(19) United States
(12) Patent Application Publication
(10) Pub. No.: US 2013/0038594 A1
(43) Pub. Date: Feb. 14, 2013

(54) INTERFACE CIRCUIT OF DISPLAY PANEL AND DISPLAY PANEL

(71) Applicant: Yong Wang, Beijing (CN)

(72) Inventor: Yong Wang, Beijing (CN)

(73) Assignee: ANALOGIX (CHINA) SEMICONDUCTOR, INC., Beijing (CN)

(21) Appl. No.: 13/142,387

(22) PCT Filed: Sep. 3, 2010
(86) PCT No.: PCT/CN2010/076612

§ 371 Date: Jun. 27, 2011

(30) Foreign Application Priority Data
May 4, 2010 (CN) 201010168161.3

(51) Int. Cl. G06F 3/038

(52) U.S. Cl. 345/212

(57) ABSTRACT

The present invention discloses an interface circuit of a display panel and a display panel. The interface circuit of the display panel is connected with a source driver, comprising: a constant current source; a first resistor; a first triode, a gate electrode connected to a first signal input terminal, a source electrode connected to a first terminal of the constant current source, and a drain electrode connected to a first input terminal of a receiving circuit, wherein, the first input terminal of the receiving circuit is connected to a first voltage of the source driver via the first resistor; a second resistor; a second triode, a gate electrode connected to a second signal input terminal, a source electrode connected to a second terminal of the constant current source, and a drain electrode connected to a second input terminal of the receiving circuit, wherein, the second input terminal of the receiving circuit is connected to the first voltage of the source driver via the second resistor. The present invention can effectively reduce the power consumption in a differential signal circuit.

### TECHNICAL FIELD

The present invention relates to an interface circuit of a display panel and a display panel.

### BACKGROUND ART

With developments of computer technology, higher demands on saving energy for computer are put forward, and various energy-saving methods occur in relevant technology. The interface circuit of a display panel has obvious influence on the power consumption of the computer. In current computers, an LVDS (Low-Voltage Differential Signaling) is used as the interface circuit of a display panel.

FIG. 1 is a schematic view of the interface circuit of a display panel according to a relevant technology.

When the interface circuit shown in FIG. 1 is used, the LVDS (or mLVDS, RVDS, AVDS, and etc.) usually needs a common-mode voltage of 1.1V to 1.3V.

When the LVDS is used, a common-mode feedback circuit (short for CMFB) is needed at a TX terminal (sending terminal), and at an RX terminal (receiving terminal), the common-mode voltage will change sharply and requires complex RX circuit designs. If the common-mode voltage is restricted between 1.1V and 1.3V, the power supply at the TX and the RX is usually higher than 1.8V. Hence, the above technical solution could hardly effectively reduce power consumption.

Currently there is not any effective solution for the problem of high power consumption of a differential signal circuit in relevant technologies.

### SUMMARY OF THE INVENTION

The present invention is put forward in view of the problem of high power consumption of the differential signal circuit, and therefore, the main object of the present invention is to provide an interface circuit of a display panel and a display panel to solve the above problem.

To achieve the above object, according to one aspect of the present invention, an interface circuit of a display panel is provided.

The interface circuit of a display panel according to the present invention is connected with a source driver, comprising: a constant current source; a first resistor; a first triode, a gate electrode of which is connected to a first signal input terminal, a source electrode of which is connected to a first terminal of the constant current source, and a drain electrode of which is connected to a first input terminal of a receiving circuit, wherein, the first input terminal of the receiving circuit is connected to a first voltage of the source driver via the first resistor; a second resistor; a second triode, a gate electrode of which is connected to a second signal input terminal, a source electrode of which is connected to a second terminal of the constant current source, and a drain electrode of which is connected to a second input terminal of the receiving circuit, wherein, the second input terminal of the receiving circuit is connected to the first voltage of the source driver via the second resistor.

Further, the drain electrode of the first triode is connected to a first node, wherein, the first node is a node between the first resistor and the first input terminal of the receiving circuit; and the drain electrode of the second triode is connected to a second node, wherein, the second node is a node between the second resistor and the second input terminal of the receiving circuit.

Further, the first input terminal of the receiving circuit is a first differential signal input terminal; and the second input terminal of the receiving circuit is a second differential signal input terminal.

Further, the above interface circuit further comprises: a third resistor, wherein, the drain electrode of the first triode is connected to a sending terminal power supply voltage via the third resistor and connected to the first node via a third node, wherein, the third node is a node between the drain electrode of the first triode and the third resistor; and a fourth resistor, wherein, the drain electrode of the second triode is connected to a sending terminal power supply voltage via the fourth resistor and connected to the second node via a fourth node, wherein, the fourth node is a node between the drain electrode of the second triode and the fourth resistor.

Further, a first capacitor is provided between the third node and the first node; and a second capacitor is provided between the fourth node and the first node.

Further, the drain electrode of the first triode is connected to the first node via the third node, wherein a first capacitor is provided between the third node and the first node; and the drain electrode of the second triode is connected to the second node via the fourth node, wherein a second capacitor is provided between the fourth node and the second node.

To achieve the above object, according to another aspect of the present invention, a display panel is provided which comprises any of the above interface circuit.

Further, the display panel is an LCD panel or an LED display panel.

To achieve the above object, according to another aspect of the present invention, a computer is provided which comprises any of the above display panel.

With the present invention, the interface circuit of a display panel with the following structure is adopted, and the interface circuit is connected with a source driver and comprises: a constant current source; a first resistor; a first triode, a gate electrode connected to a first signal input terminal, a source electrode connected to a first terminal of the constant current source, and a drain electrode connected to a first input terminal of a receiving circuit, wherein, the first input terminal of the receiving circuit is connected to a first voltage of the source driver via the first resistor; a second resistor; a second triode, a gate electrode connected to a second signal input terminal, a source electrode connected to a second terminal of the constant current source, and a drain electrode connected to a second input terminal of the receiving circuit, wherein, the second input terminal of the receiving circuit is connected to the first voltage of the source driver via the second resistor. Hence, the problem of high power consumption of the differential signal circuit is solved and thus the effect of effectively reduce the power consumption of the differential signal circuit is achieved.

### BRIEF DESCRIPTION OF THE DRAWINGS

The accompanying drawings herein are used to provide further understanding of the present invention and constitute a part of the present application. The illustrative embodiments of the present invention and the description thereof are used to explain the present invention and do not constitute improper restrictions on the same. As shown in the drawings:

FIG. 1 is a schematic view of the interface circuit of a display panel according to a relevant technology;

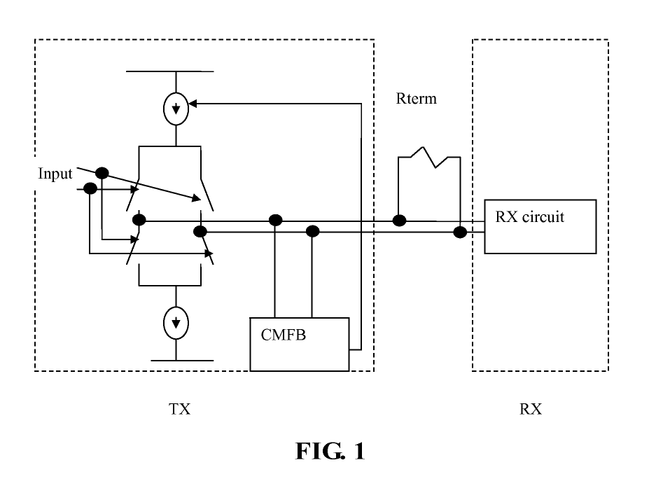

FIG. 2 is a schematic view of the interface circuit of a display panel according to a first embodiment of the present invention; and

FIG. 3 is a schematic view of the interface circuit of a display panel according to a second embodiment of the present invention.

### DETAILED DESCRIPTION OF THE EMBODIMENTS

It should be clarified that in the case of no conflict, the embodiments in the present application and the features in the embodiments can be combined. The present invention will be detailed hereinafter in conjunction with the figures and the embodiments.

According to the embodiments of the present invention, an interface circuit of a display panel and a display panel are provided.

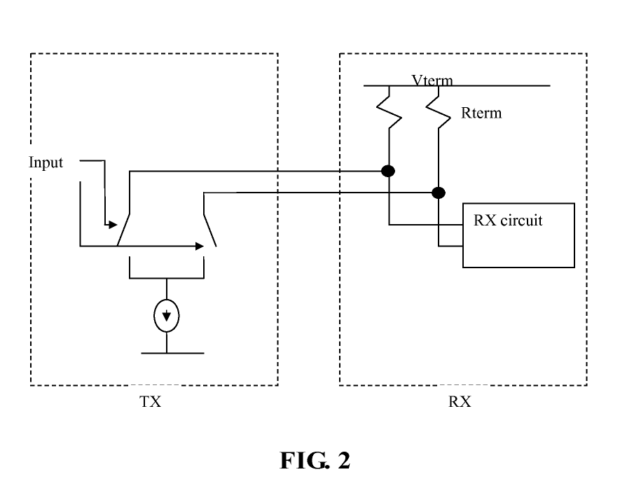

FIG. 2 is a schematic view of the interface circuit of a display panel according to a first embodiment of the present invention.

As shown in FIG. 2, the interface circuit of the display panel is connected with a source driver and comprises: a constant current source; a first resistor; a first triode, a gate electrode of which is connected to a first signal input terminal, a source electrode of which is connected to a first terminal of the constant current source, and a drain electrode of which is connected to a first input terminal of a receiving circuit, wherein, the first input terminal of the receiving circuit is connected to a first voltage Vterm of the source driver via the first resistor; a second resistor; a second triode, a gate electrode of which is connected to a second signal input terminal, a source electrode of which is connected to a second terminal of the constant current source, and a drain electrode of which is connected to a second input terminal of the receiving circuit, wherein, the second input terminal of the receiving circuit is connected to the first voltage Vterm of the source driver via the second resistor.

The source driver can have multiple voltages, and the above first voltage Vterm can be any one of the voltages of the source driver.

The above triode can be a PMOS transistor or NMOS transistor, or it can also be a PNP or NPN triode.

As shown in the figure, the above triode is located at a TX terminal (a sending terminal), wherein, the TX terminal is a control terminal and can comprise an input device (such as mouse and keyboard), CPU and etc. The gate electrode of the triode is a control terminal.

In the above interface circuit, the voltage of the source driver can be set at random, for example, it can be 1V, and then it is obviously lower than the voltage in the relevant technology, thereby obviously reduce the power consumption.

As shown in the figures, in the above interface circuit, the first voltage of the source driver is connected to the first input terminal of the receiving circuit via the first resistor (as a differential signal flows through the interface, the receiving circuit has two input terminals, and the first input terminal can be either of the input terminals of the receiving circuit), and the first voltage of the source driver is connected to the second input terminal of the receiving circuit via the second resistor, wherein, the drain electrode of the first triode is connected to a first node, wherein, the first node is a node between the first resistor Rterm (which can be either of the two resistors of the receiving terminal RX) and the first input terminal of the receiving circuit; and the drain electrode of the second triode is connected to a second node, wherein, the second node is a node between the second resistor Rterm (which can be either of the two resistors of the receiving terminal RX and is different from the first resistor) and the second input terminal of the receiving circuit.

Preferably, the drain electrode of the first triode is connected to a first node, wherein, the first node is a node between the first resistor and the first input terminal of the receiving circuit; and the drain electrode of the second triode is connected to a second node, wherein, the second node is a node between the second resistor and the second input terminal of the receiving circuit.

The first input terminal of the receiving circuit is a first differential signal input terminal; and the second input terminal of the receiving circuit is a second differential signal input terminal.

As shown in FIG. 2, the above first triode and the second triode are two triodes of the sending terminal, the first resistor and the second resistor are two resistors of the receiving terminal, and the first node and the second node are two nodes shown in the receiving terminal.

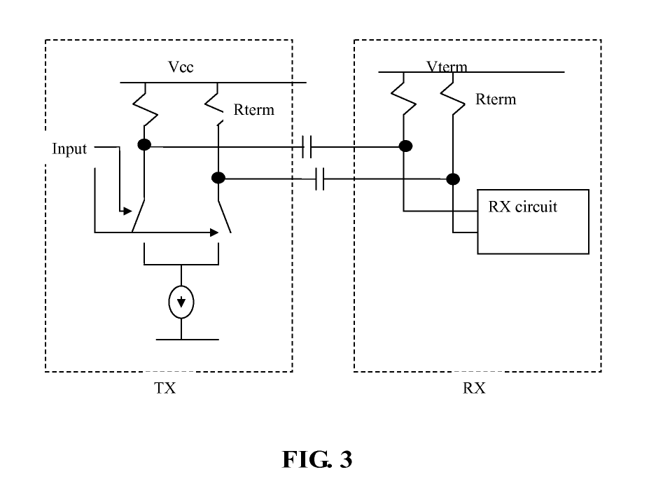

In the embodiments of the present invention, to save energy, the CMFB need not be used, and the termination of the TX is provided at the RX side, the termination of the TX and the RX terminal are both connected to the power supply of the RX or other voltages shown in FIG. 2. FIG. 3 is a schematic view of another embodiment for eliminating the common-mode demand.

FIG. 3 is a schematic view of the interface circuit of a display panel according to a second embodiment of the present invention.

As shown in FIG. 3, in the interface circuit of this embodiment, a power supply voltage portion of the sending terminal is added. Also, as a capacitor having the function of blocking is added, the interface circuit is applicable to AC signals.

As shown in the figures, the interface circuit of the display panel is connected with a source driver, comprising: a constant current source; a first resistor; a first triode, a gate electrode of which is connected to a first signal input terminal, a source electrode of which is connected to a first terminal of the constant current source, and a drain electrode of which is connected to a first input terminal of a receiving circuit, wherein, the first input terminal of the receiving circuit is connected to a first voltage Vterm of the source driver via the first resistor; a second resistor; a second triode, a gate electrode of which is connected to a second signal input terminal, a source electrode of which is connected to a second terminal of the constant current source, and a drain electrode of which is connected to a second input terminal of the receiving circuit, wherein, the second input terminal of the receiving circuit is connected to the first voltage Vterm of the source driver via the second resistor, wherein, the above interface circuit further comprises: a third resistor, wherein, the drain electrode of the first triode is connected to a sending terminal power supply voltage Vcc via the third resistor and connected to the first node via a third node, wherein, the third node is a node between the drain electrode of the first triode and the third resistor; and a fourth resistor, wherein, the drain electrode of the second triode is connected to a sending terminal power supply voltage Vcc via the fourth resistor and connected to the second node via a fourth node, wherein, the fourth node is a node between the drain electrode of the second triode and the fourth resistor.

A first capacitor is provided between the third node and the first node; and a second capacitor is provided between the fourth node and the first node.

The above first and second nodes are the same with the first and second nodes in a first embodiment.

As shown in FIG. 3, the above first triode and the second triode are two triodes of the sending terminal, the first resistor and the second resistor are two resistors of the receiving terminal, the first node and the second node are two nodes shown in the receiving terminal, the third node and the fourth node are two nodes shown in the sending terminal, and the third and the fourth resistors are two resistors shown in the sending terminal.

In another embodiment according to the present invention, the drain electrode of the first triode is connected to the first node via the third node, wherein, a first capacitor is provided between the third node and the first node; the drain electrode of the second triode is connected to the second node via the fourth node, wherein, a second capacitor is provided between the fourth node and the second node.

The sizes of the above capacitors are specifically determined according to the transmission rates of the signals.

In the solution of the present invention, the termination voltage of the TX can be set as any voltage, the design of the RX circuit is made easier, and eliminating the CMFB can make the design of the TX easier and reduce a die size. Due to satisfactory energy saving, compared with 2.5V or 3.3V of the LVDS and the AVDS, the Vterm can be reduced to 1V, thereby achieving the effect of obviously reducing the power consumption.

The above solution of the present invention can be applied to a panel (for example, an LCD display panel, an LED display panel, and etc.), and needs ultra low power to transmit data to the source driver of the panel.

From the above description, it is seen that the present invention achieves the following technical effects:

1. the design of the sending terminal and the receiving terminal is simpler;

2. the die size is small; and

3. the power consumption of the display panel can be reduced obviously.

The descriptions above are only preferable embodiments of the present invention and are not used to restrict the present invention. For those skilled in the art, the present invention can have various changes and variations. Any modifications, equivalent substitutions, improvements etc. within the spirit and principle of the present invention shall all be included in the scope of protection of the present invention.

1. An interface circuit of a display panel, connected with a source driver, comprising:
a constant current source;
a first resistor;
a first triode, a gate electrode of which being connected to a first signal input terminal, a source electrode of which being connected to a first terminal of the constant current source, and a drain electrode of which being connected to a first input terminal of a receiving circuit, wherein, the first input terminal of the receiving circuit is connected to a first voltage of the source driver via the first resistor;
a second resistor;
a second triode, a gate electrode of which being connected to a second signal input terminal, a source electrode of which being connected to a second terminal of the constant current source, and a drain electrode of which being connected to a second input terminal of the receiving circuit, wherein, the second input terminal of the receiving circuit is connected to the first voltage of the source driver via the second resistor.

2. The interface circuit according to claim 1, wherein:
the drain electrode of the first triode is connected to a first node, wherein, the first node is a node between the first resistor and the first input terminal of the receiving circuit; and
the drain electrode of the second triode is connected to a second node, wherein, the second node is a node between the second resistor and the second input terminal of the receiving circuit.

3. The interface circuit according to claim 2, wherein, the first input terminal of the receiving circuit is a first differential signal input terminal; and the second input terminal of the receiving circuit is a second differential signal input terminal.

4. The interface circuit according to claim 2, wherein, the interface circuit further comprising:
a third resistor, wherein, the drain electrode of the first triode is connected to a sending terminal power supply voltage via the third resistor and connected to the first node via a third node, wherein, the third node is a node between the drain electrode of the first triode and the third resistor; and
a fourth resistor, wherein, the drain electrode of the second triode is connected to a sending terminal power supply voltage via the fourth resistor and connected to the second node via a fourth node, wherein, the fourth node is a node between the drain electrode of the second triode and the fourth resistor.

5. The interface circuit according to claim 4, wherein, a first capacitor is provided between the third node and the first node; and a second capacitor is provided between the fourth node and the first node.

6. The interface circuit according to claim 2, wherein
the drain electrode of the first triode is connected to the first node via a third node, wherein a first capacitor is provided between the third node and the first node; and
the drain electrode of the second triode is connected to the second node via a fourth node, wherein a second capacitor is provided between the fourth node and the second node.

7. A display panel, comprising the interface circuit according to claim 1.

8. The display panel according to claim 7, wherein, the display panel is an LCD display panel or an LED display panel.
